(19) United States
(12) Patent Application Publication
(10) Pub. No.: US 2009/0288616 A1
(43) Pub. Date: Nov. 26, 2009

(54) Pet Identification and Retrieval System

(76) Inventor: Beverly Ann Csenar, Roswell, GA (US)

Correspondence Address: KAPLAN WARD & PATEL LLC, CUMBERLAND CENTER II, 3100 CUMBERLAND BLVD , SUITE 1400, ATLANTA, GA, 30339, US

(21) Appl. No.: 12/470,879

(22) Filed: May 22, 2009

Related U.S. Application Data
(60) Provisional application No. 61/128,656, filed on May 24, 2008.

(51) Int. Cl. A01K 27/00; G08B 23/00; G06F 17/30

(52) U.S. Cl. 119/858; 340/573.1; 707/3; 707/E17.014

(57) ABSTRACT

Disclosed is a pet collar comprising a firmly affixed identification tag system with encoded identifier, and a related system and method providing for association of said encoded identifier with one or more webpages providing owner-specified information about the pet, and for assisting an owner's recovery of said pet, if lost.

### RELATED APPLICATIONS

Priority is claimed to U.S. provisional patent application Ser. No. 61/128,656 filed on May 24, 2008.

### TECHNICAL FIELD

The present invention relates, generally, to a pet identification apparatus and related system for assisting an owner's recovery of a lost pet, and, more particularly, to a pet collar comprising a firmly affixed identification tag system with encoded identifier, and a related system and method providing for association of said encoded identifier with one or more webpages providing owner-specified information about the pet, and for assisting an owner's recovery of said pet, if lost.

### BACKGROUND OF THE INVENTION

Conventional pet tags are used for a variety of purposes, including identification of the animal by name, and to convey the owner's address and/or phone number, or other like information. Pet tags are also typically used for identification of the status of community licensure of the pet, including certification of the current year's inoculation or vaccination for disease, such as rabies. Sometimes the tag may include veterinarian contact information, or the like. Pet owners universally trust and hope that, if their beloved pet should become lost, the tag(s) will provide critical information necessary for a successful and safe recovery, medical treatment (if necessary), and return, of the pet.

Consistent with such purposes, such tags are often obtained or purchased separately from the pet's collar, and are mounted thereupon in a fashion so as to dangle from a ring or buckle affixed to the collar. It is also typical that a pet's collar will have a plurality of such tags dangling therefrom, each such tag providing unique, relevant information.

Disadvantageously, however, such tags are prone to falling off and becoming lost. Further disadvantageously, such tags may become caught in or upon fences, gates, landscaping, home furnishings, and the like; thereby, endangering the animal. Such tags tend to be sonorous and, thereby, can be distracting or even irritating to the owner (e.g., during the night); and this is especially so when a plurality of such tags hang adjacent one-another from a pet's collar.

Such tags tend to wear poorly, becoming scuffed, scratched, weathered, and/or faded over time; thereby, rendering the information carried thereupon difficult, if not impossible, to perceive. Such degradation can often impair the very purpose for the tag; to wit, the transmittal of relevant information necessary to recover, medically treat, and return a lost pet.

Still further disadvantageously, and as described in-part above, the nature, amount, and degree of information that may be carried upon such a tag is limited. There is often no way for the person finding a lost pet to further identify the pet, its temperament or other defining characteristics, medical needs, food-related information, detailed owner information, or the like, beyond that which is printed or engraved upon the tag, and, even then, only to the extent that such information is clear enough to be readily perceived.

Therefore, what is needed to address the above-noted disadvantages, but which has not heretofore been available, is a novel pet collar comprising a firmly affixed identification tag system with encoded identifier, and a related system and method providing for association of said encoded identifier with one or more webpage providing owner-specified information about the pet, and for assisting an owner's recovery of said pet, if lost.

### BRIEF SUMMARY OF THE INVENTION

Briefly described, in a preferred embodiment, the apparatus, system and method of the present invention overcome the above-mentioned disadvantages, and meet the recognized need, by providing an apparatus, system, and method for pet identification and retrieval.

According to its major aspects, and broadly stated, an exemplary apparatus, system, and method according to the present invention provides a pet collar comprising a firmly affixed identification tag system with encoded identifier, and a related system and method providing for association of said encoded identifier with one or more webpage providing owner-specified information about the pet, and for assisting an owner's recovery of said pet, if lost.

Specifically, according to the preferred embodiment of the present invention, a uniquely configured, collar-mounted pet tag is associated with a website that effectively allows the finder of a lost pet to contact the pet's owner. A durable, preferably metal, tag is riveted to a pet's collar. The tag is formed and covered with a label, on which label is inscribed a website address and a unique, encoded, numeric identifier. The label is protected by a polyurethane coating, typically in the form of an overlying, domed layer, to protect the label from wear and weathering. The encoded, numeric identifier directs the finder of a lost pet to the relevant website, and to an associated webpage for the pet, the webpage having been created by the pet owner after purchase of the collar. The webpage can be configured to store all relevant information about the pet, as well as detailed instructions for contacting the pet's owner.

Accordingly, the primary function of the present invention is to connect a pet owner with his or her lost pet. When a pet wearing the collar of the present invention is found, the finder accesses the specified website, presently found at www.myecollar.com. The encoded, numeric identifier found on the tag gives the pet finder access to the pet owner's detailed contact instructions. Pet finders only need go to said website to find the owner of the pet, and included security precautions ensure that the pet owner's personal information is not released in an unintended manner.

A secondary function of the present invention is to provide a network within which a pet owner may create a webpage for his or her pet, and where they can place information about the pet, such as, but not limited to, medical history, pet photos, and detailed ancillary information. The pet owner advantageously may, in accordance with social networking functions provided by said website, conduct other communications over the internet to and with interested third parties, including other similarly interested pet owners.

Accordingly, one feature and advantage of the apparatus, system, and method of the present invention is the provision of a pet collar comprising a firmly affixed identification tag system with encoded identifier.

Another feature and advantage of the apparatus, system, and method of the present invention is the provision of a means for association of said encoded identifier with one or more webpage providing owner-specified information about the pet, and for assisting an owner's recovery of said pet, if lost.

Another feature and advantage of the apparatus, system, and method of the present invention is the provision of a means whereby a pet owner may access a website and create a webpage for his or her pet, and may, in accordance with social networking functions provided by said website, conduct other communications over the internet to and with interested third parties, including other similarly interested pet owners.

Another and further feature and advantage of the apparatus, system, and method of the present invention is the provision of a collar and associated tag apparatus that is quiet when worn by a pet.

Another and further feature and advantage of the apparatus, system, and method of the present invention is the provision of a tag apparatus that is not easily dislodged from the collar, not easily lost, not easily caught upon fences, gates, landscaping, home furnishings, and the like, and not easily degraded by scuffing, scratching, weathering, and/or fading over time.

These and other features and advantages of the system and method of the present invention will become apparent to those ordinarily skilled in the art after reading the following Detailed Description of the Invention and Claims in light of the accompanying drawing Figures.

### BRIEF DESCRIPTION OF THE DRAWINGS

Accordingly, the system and method of the present invention will be understood best through consideration of, and with reference to, the following drawings, viewed in conjunction with the Detailed Description of the Invention referring thereto, in which like reference numbers throughout the various drawings designate like structure, and in which:

FIG. 1 depicts the preferred embodiment of a tag apparatus constructed according to the present invention and further depicted as affixed to a pet collar;

FIG. 2 depicts a side, exploded view of the preferred embodiment of the apparatus of FIG. 1;

FIG. 3 depicts a top view of the tag element of the preferred embodiment of the apparatus of FIG. 1;

FIG. 4 depicts a home webpage for providing access to various features of the system and method of a preferred embodiment of the present invention;

FIG. 5 depicts a registration webpage for an owner's registration of a tag apparatus of FIG. 1;

FIG. 6 depicts a pet-specific webpage for an owner's entry of information relevant to the pet intended to wear the tag apparatus of FIG. 1, and for subsequent retrieval by a finder of said pet, if lost; and

FIG. 7 depicts a webpage for entry, by the finder of a pet wearing a tag apparatus of FIG. 1, of an encoded, numeric identifier carried by said tag apparatus, and for providing access to detailed information concerning said recovered pet and its safe handling, care, and return.

It is to be noted that the drawing Figures presented are intended solely for the purpose of illustration and that they are, therefore, neither desired nor intended to limit the claimed invention to any or all of the exact details of construction shown, except insofar as they may be deemed essential to the claimed invention.

### DETAILED DESCRIPTION OF THE INVENTION

In describing preferred embodiments of the system and method of the present disclosure illustrated in the drawing Figures, specific terminology is employed for the sake of clarity. The claimed invention, however, is not intended to be limited to the specific terminology so selected, and it is to be understood that each specific element includes all technical equivalents that operate in a similar manner to accomplish a similar purpose.

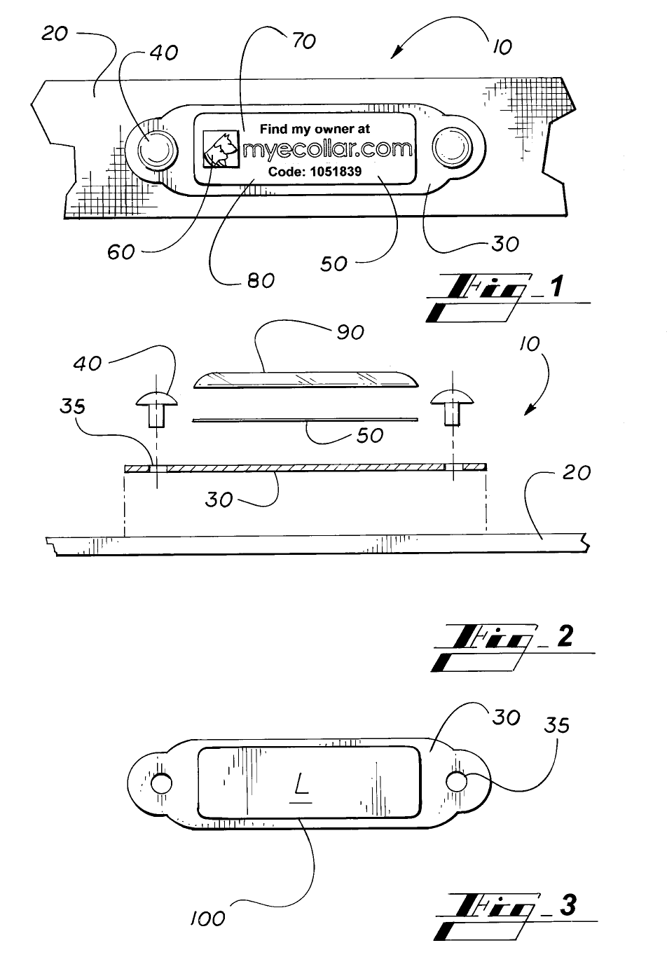

The disclosure set forth hereinbelow generally provides an exemplary, preferred apparatus, system, and method according to the present invention. Accordingly, and in that form of the preferred embodiment of the present invention chosen for purposes of illustration, FIG. 1 shows collar apparatus 10 comprising collar 20 and tag 30.

In the preferred embodiment, collar 20 is formed from a woven nylon material, having such desirable characteristics as strength, tear and puncture resistance, and water, mold, and mildew resistance. Tag 30 is preferably fabricated from an appropriate composition of stainless steel, and is formed into an appropriate shape for a tag consistent with the uses and purposes described herein, as through machine operations such as stamping, cutting, or milling. It will be apparent to those of ordinary skill in the art that stainless steel is selected for its characteristic resistance to ferrous corrosion, its ability to self-heal when scratched or scuffed, and its strength and rigidity.

In alternative embodiments, however, it will be appreciated that collar 20 may be formed from any material consistent with the uses and purposes described herein. For example, as with typical pet collars, collar 20 may be formed of leather, cloth, Kevlar, composites, or the like. It will further be appreciated that tag 30 may be formed of plastics, non-metallic composites, non-ferrous metals (e.g., brass, bronze), weather-resistant, treated, or coated metals, or the like.

Tag 30 is attached to collar 20 through the use of dome head rivets 40, in order that the attachment means be smooth to touch, and generally resistant to snagging and/or catching upon fences, gates, landscaping, home furnishings, clothes, skin, hair, and the like. Similarly, rivets 40 are chosen so that the underside of collar 20 remains smooth and unobstructed by protruding fastener elements. Notwithstanding, it will be apparent to one of ordinary skill in the art that alternative fastening means consistent with the uses and purposes described herein may be used.

To tag 30 is applied label 50, typically of paper or cloth, and which further may have an adhesive backing of any type known in the art. Label 50 is preprinted, as by offset printing, silk-screening, or the like, with one or more of logo 60, website address 70, and an encoded, numeric identifier 80, the uses and purposes of which will be detailed hereinbelow. Label 50 may be formed of a light-reflective material, or may be treated to provide light-reflecting characteristics. It is additionally contemplated that the information carried, or otherwise to be carried, by label 50 may, in a suitable instance, be printed, silk-screened, or otherwise applied directly to tag 30.

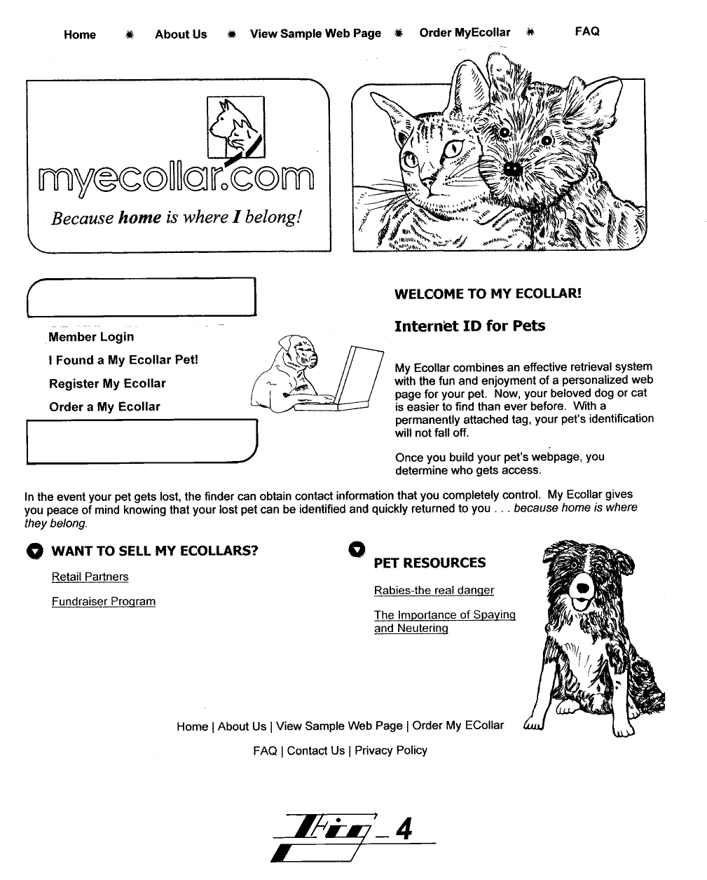

Turning now to FIG. 2, an exploded view of collar apparatus 10 better illustrates the preferred construction thereof. It can be further observed in FIG. 2 that rivets 40 are passed through holes 35 formed within tag 30, whereupon rivets 40 may be used to affix tag 30 to collar 20 as described above. It will be further apparent that label 50 may be placed into position upon tag 30 and, optionally, overcoated with an epoxy, or the like, for permanence and/or moisture resistance.

With continuing reference to FIG. 2, it may be seen that dome 90 is applied over label 50 to complete collar apparatus 10. Dome 90 is preferably an optically clear material, such as resin or polyurethane, and which preferably comprises a thickness of greater than approximately 4 millimeters. Dome 90 may be affixed by optically clear adhesive, epoxy, urethane, resin, or the like, and provides further water and environmental resistance to protect and preserve underlying label 50. It is further contemplated that label 50 may be incorporated into, or encapsulated within, dome 90, as manufacturing methods may permit now or in the future, to further enhance and optimize the desired characteristics described herein. In any event, dome 90 is smooth to touch and has a low profile; thereby, providing a further impediment to snagging and/or catching upon fences, gates, landscaping, home furnishings, clothes, skin, hair, and the like.

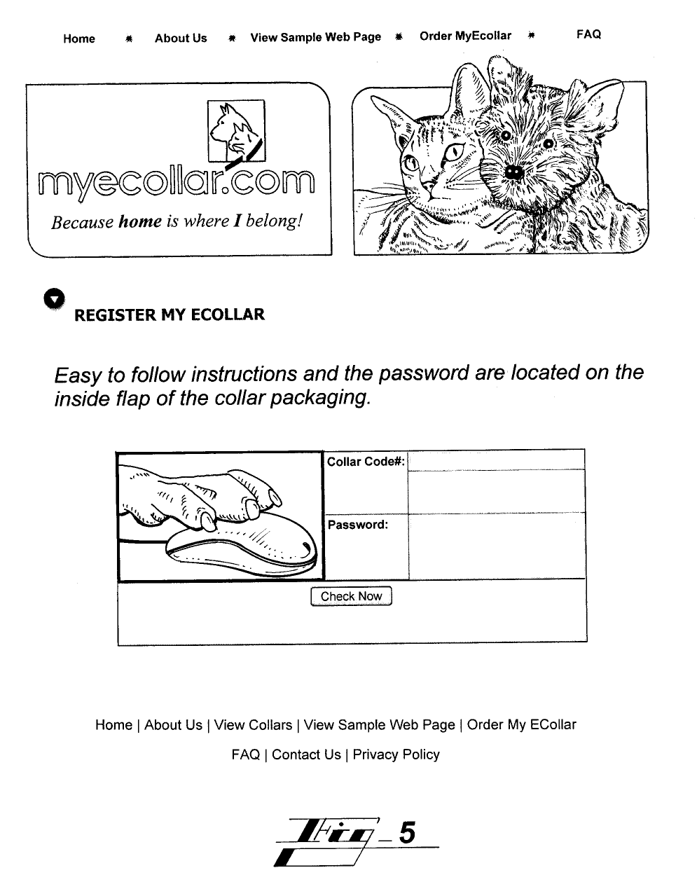

Turning now to FIG. 3, tag 30 may be seen to further comprise label affixation region L, preferably bounded by guide markings 100. Guide markings 100 may be etched, scribed, stamped, or otherwise formed upon the surface of tag 30, and may serve to provide for ease of placement and orientation of label 50 and dome 90 upon tag 30.

Accordingly, it will be observed that collar apparatus 10 of the present invention, when constructed substantially as described hereinabove, is quiet when worn by a pet; is not easily dislodged from the collar, not easily lost, not easily caught upon fences, gates, landscaping, home furnishings, clothes, skin, hair, and the like; and is not easily degraded by scuffing, scratching, weathering, and/or fading over time. Thus, it is hoped that a pet wearing collar apparatus 10 will be safer, and that long-term readability of label 50 is preserved and enhanced over that provided by conventional tags, leading to a better chance of recovery of the pet, if lost, by its owner.

According to the system and method of use of the present invention, label 50 bears a reference and related instruction to access website at address 70, currently located at http://www.myecollar.com. Upon a user's successful access of the website at address 70, various options are presented.

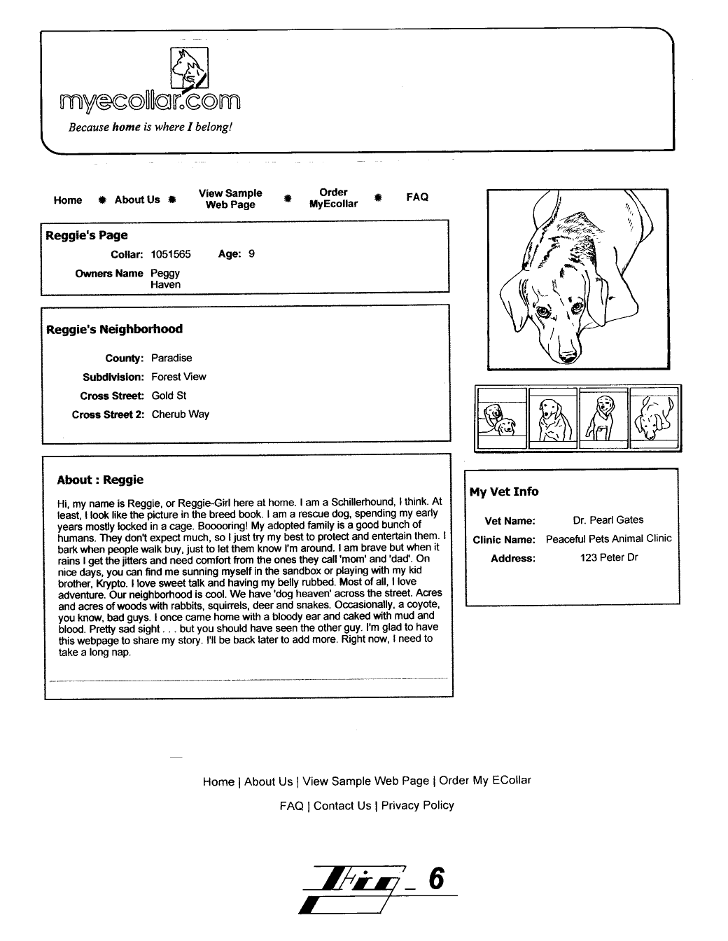

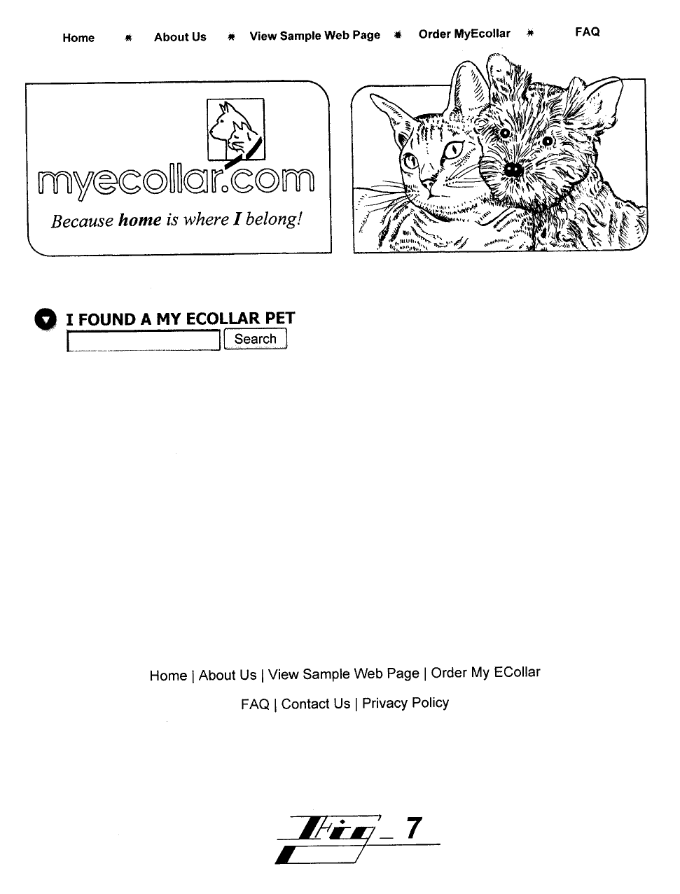

For example, and with reference to FIG. 4, when an owner purchases collar apparatus 10, and visits the website at address 70, currently located at http://www.myecollar.com, he or she is presented with the option, such as seen in FIG. 5, to register the collar apparatus using encoded, numeric identifier 80. The owner may establish a confidential username and password, as is well-known in the art. The owner may then proceed to establish a webpage for the relevant pet, such as seen in FIG. 6, entering into a provided template such information as the pet's name, photos, address, medical conditions and needs, food and treat preferences, veterinary contact information, pet temperament and personality traits, specific do's and don'ts for handling the pet, alternative means to contact the owner, and the like. The web page also provides a vehicle for the pet owner to express his or her creativity, and to convey the owner's personality and character, as well as that of the pet.

The pet owner advantageously may, in accordance with social networking functions that may optionally be provided by said website, conduct other communications over the internet to and with interested third parties, including other similarly interested pet owners, family, and friends.

On the other hand, and with continuing reference to FIG. 4, encoded, numeric identifier 80 directs the finder of a lost pet to the relevant website at address 70, currently located at http://www.myecollar.com, whereupon, as seen in FIG. 7, he or she is presented with an option to enter encoded, numeric identifier 80 and, thereby, to be directed to the pet's website, seen in FIG. 6, as was previously established by the pet's owner. The pet's finder is then provided with a wealth of detailed information enabling him or her to adequately handle and care for the pet until it can be safely returned to its owner, and to have similarly detailed information at hand for immediate use in contacting the pet's owner and/or veterinarian. Accordingly, the system and method of the present invention conveniently and securely provides better, more detailed and accurate information than can be carried upon a conventional tag, and has the further advantage of being easily updated by the owner without the time and expense of replacement of said tag.

Having thus described exemplary embodiments of the present invention, it should be noted by those skilled in the art that the within disclosures are exemplary only and that various other alternatives, adaptations, and modifications may be made within the scope and spirit of the present invention. For example, while the system of the present disclosure has been described with regard to a single tag apparatus, a plurality of tags may be included in series or parallel arrangement in order to increase an amount, nature, degree, or quantity of information that may be carried thereupon. Similarly, the tag size and shape may be varied to accommodate collars of differing sizes, shapes, and/or configurations. Further, the encoded numeric identifier may be other than numeric, and it may be encoded to designate a specific geographic region, locale, or other useful demographic information. Additionally, the system and method of the present invention may be utilized in a manner and/or through processes other than via internet and currently available coding methodologies/tools. In this regard, it is contemplated that the general teachings hereof could be adapted to other, further, and future technologies conducive to use of the present invention. Accordingly, the present invention is not limited to the specific embodiments as illustrated herein, but is only limited by the following claims.

What is claimed is:

1. A pet collar apparatus comprising:
a. a collar;
b. a tag, said tag firmly affixed to said collar;
c. said tag comprising an electronic address and an encoded identifier; and
d. a visually clear dome through which said electronic address and encoded identifier may be perceived.

2. The pet collar apparatus of claim 1, wherein said electronic address and encoded identifier are carried by a label affixed to said tag.

3. The pet collar apparatus of claim 2, wherein said label is reflective.

4. The pet collar apparatus of claim 1, wherein said electronic address and encoded identifier are disposed upon said tag.

5. The pet collar apparatus of claim 1, wherein said dome overlies said electronic address and encoded identifier.

6. The pet collar apparatus of claim 1, wherein said dome encapsulates said electronic address and encoded identifier.

7. The pet collar apparatus of claim 1, wherein said tag is affixed to said collar by a rivet.

8. The pet collar apparatus of claim 1, wherein said tag comprises a region bounded by guide markings.

9. The pet collar apparatus of claim 1, wherein said encoded identifier is encoded to designate a geographic region or locale.

10. The pet collar apparatus of claim 1, wherein said collar is nylon.

11. The pet collar apparatus of claim 1, wherein said tag is stainless steel.

12. The pet collar apparatus of claim 1, wherein said dome is polyurethane.

13. A system for recovery of a lost pet comprising:
a. a pet collar apparatus, said apparatus comprising:
i. a collar;
ii. a tag, said tag firmly affixed to said collar;
iii. said tag comprising an electronic address and an encoded identifier; and
iv. a visually clear dome through which said electronic address and encoded identifier may be perceived;
b. means for a user's entry or retrieval of selected information associated with a pet wearing said pet collar apparatus, said means comprising:
i. an first electronic location accessible by use of said electronic address;
ii. said first electronic location providing for entry of said encoded identifier,
whereby, upon entry of said encoded identifier by a user, a second electronic location is provided for entry or retrieval of said selected information associated with the pet wearing said pet collar apparatus.

14. The system of claim 13 wherein said information associated with a pet wearing said pet collar apparatus is selected from the group consisting of: the pet's name, a photo, an address, an identification of a medical condition, a food preference, a treat preference, a veterinarian's name, a veterinarian's contact information, a description of the pet's temperament, a description of at least one of the pet's personality traits, a handling instruction for the pet, and an alternative means to contact the owner.

15. The system of claim 13, wherein said first electronic location is an internet website.

16. The system of claim 15, wherein said second electronic location is a pet-specific internet webpage associated with said internet website.

17. A method for enabling recovery of a lost pet comprising:
a. providing a pet collar apparatus, said apparatus comprising:
i. a collar;
ii. a tag, said tag firmly affixed to said collar;
iii. said tag comprising an electronic address and an encoded identifier; and
iv. a visually clear dome through which said electronic address and encoded identifier may be perceived;
b. directing a user to means for said user's entry or retrieval of selected information associated with a pet wearing said pet collar apparatus, said means comprising:
i. an first electronic location accessible by use of said electronic address;
ii. said first electronic location providing for entry of said encoded identifier,
whereby, upon entry of said encoded identifier by a user, a second electronic location is provided for entry or retrieval of said selected information associated with the pet wearing said pet collar apparatus.

18. The system of claim 17 wherein said information associated with a pet wearing said pet collar apparatus is selected from the group consisting of: the pet's name, a photo, an address, an identification of a medical condition, a food preference, a treat preference, a veterinarian's name, a veterinarian's contact information, a description of the pet's temperament, a description of at least one of the pet's personality traits, a handling instruction for the pet, and an alternative means to contact the owner.

19. The system of claim 17, wherein said first electronic location is an internet website.

20. The system of claim 19, wherein said second electronic location is a pet-specific internet webpage associated with said internet website.
